(19) United States
(12) Patent Application Publication
(10) Pub. No.: US 2008/0056396 A1
(43) Pub. Date: Mar. 6, 2008

(54) METHOD AND APPARATUS FOR QR DECOMPOSITION-BASED MIMO DETECTION AND SOFT BIT GENERATION

(75) Inventor: Yingxue Li, Exton, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/848,445

(22) Filed: Aug. 31, 2007

Related U.S. Application Data
(60) Provisional application No. 60/841,664, filed on Aug. 31, 2006.

(51) Int. Cl. H04L 27/28

(52) U.S. Cl. 375/260

(57) ABSTRACT

A method and apparatus for QR decomposition-based multiple-input multiple-output (MIMO) detection and soft bit generation are disclosed. QR decomposition is performed on the MIMO channel matrix H to compute a Q matrix and an R matrix such that H=QR. The R matrix, or diagonal elements of the R matrix, is stored in a memory. An \tilde{R} matrix is computed by dividing elements in each row of the R matrix with a corresponding diagonal element of the R matrix. A \tilde{Y} vector is computed by dividing each element of the received symbol vector Y with a corresponding diagonal element of the R matrix. A tree search process is performed using the \tilde{R} matrix and the \tilde{Y} vector to generate an approximate maximum likelihood (ML) estimate of transmitted symbols.

### CROSS REFERENCE TO RELATED APPLICATION

This application claims the benefit of U.S. provisional application No. 60/841,664 filed Aug. 31, 2006, which is incorporated by reference as if fully set forth.

### FIELD OF INVENTION

The present invention is related to wireless communication systems. More particularly, the present invention is related to a method and apparatus for QR decomposition-based multiple-input multiple-output (MIMO) detection and soft bit generation.

### BACKGROUND

To improve spectral efficiency, a MIMO technique has been widely adapted into various wireless communication standards, such as IEEE 802.16, 802.11n and evolved universal terrestrial radio access (E-UTRA). In MIMO systems, multiple data streams are transmitted over multiple antennas in the same frequency-time block. Low complexity MIMO receivers employ linear receivers, such as a zero-forcing (ZF) or minimum mean squared error (MMSE) receiver. However, the performance of the ZF or MMSE receiver is not optimum. A receiver based on maximum likelihood (ML) detection is optimum, but requires prohibitively high complexity. A near optimum receiver based on a QR decomposition (QRD) technique has been proposed. The QRD-based receiver offers performance near that of a maximum likelihood detection (MLD) receiver with reduced complexity. A QRD-based receiver that implements an M algorithm is often referred to as a QRD-M receiver, where M is the size of a survival candidate used in a tree search process.

A MIMO system with P transmit antennas and K receive antennas is denoted as a P×K system. The P×K system is represented as follows:
Y=HX+N; Equation (1)
where X is a P×1 vector representing transmitted symbols, Y is a K×1 vector representing received symbols, N is a K×1 vector representing noise, and H is a K×P channel matrix with element hₖₚ representing channel response between p-th transmit antenna and k-th receive antenna.

The QRD-M receiver computes a MIMO channel matrix H, and performs QR decomposition of the channel matrix H as follows:

$$H = QR = Q ( \begin{matrix}{r}_{11} & {r}_{12} & … & {r}_{1 P} \\ 0 & {r}_{22} & … & ⋮ \\ 0 & 0 & ⋰ & {r}_{PP} \\ 0 & 0 & 0 & 0\end{matrix} ) ; \qquad Equation ( 2 )$$

where Q is a unitary matrix, and R is an upper triangular matrix.

The receiver then performs transformation of the received symbol vector Y as follows:
\tilde{Y}=Q^{H}Y=RX+Ñ. Equation (3)

The receiver then performs a tree search with M survival candidates. Starting from the last element zₚ=\tilde{y}ₚ at the first stage, the receiver calculates metrics, (i.e., squared Euclidean distance (SED)), with respect to all constellation points and selects a predetermined number M of candidates having the smallest metrics as surviving candidates. At the (P-t+1)-th stage, there are total M surviving candidates from previous stages. Each of M candidates is associated with an accumulated SED (ASED) {Aₘ}, and a symbol sequence corresponding to the ASED. For m-th surviving candidate, contribution from previous layer data {xₘₙ; n=t+1, t+2, . . . P} corresponding to the surviving candidate is subtracted from the received signal as follows:

$${z}_{mt} = {\tilde{y}}_{t} - {\sum }_{n = t + 1}^{P} {γ}_{i n} {x}_{mn} . \qquad Equation ( 4 )$$

Corresponding to each constellation point c_{g}, a metric is calculated as follows:
λ_{mg}²=|zₘₜ−γₜₜc_{g}|²; Equation (5)
which requires six (6) real multiplications. Equation (5) is repeated for all constellation points.

A set of temporary ASED is then calculated as:
μ_{mg}=Aₘ+λ_{mg}². Equation (6)

Equations (4), (5), (6) are repeated for all M surviving candidates to generate a set of temporary ASEDs, out of which M surviving candidates with least ASED are selected for the next layer. The process continues until all P layers are processed.

If the number of surviving candidates is M at each stage, and assuming the size of modulation alphabet to be G, the total MG metrics, (i.e., SEDs), need to be calculated. The total complexity of QRD-M MIMO receiver can be approximated in terms of the number of real multiplications is 6MPG. An MLD MIMO receiver would have complexity of 6G^{P}.

For comparison, considering a 4×4 MIMO system (P=4, K=4) with 64 quadrature amplitude modulation (64QAM) modulation (G=64) and a survival candidate size M=16, the QRD-M receiver would only require 0.024% complexity of the brute-force MLD receiver.

Although the complexity is reduced compared to the MLD receiver, the complexity of the conventional QRD-M MIMO receiver is still prohibitive for some applications such as mobile handsets. Therefore, further complexity reduction is desired.

Moreover, the conventional QRD-M receiver has problems in generating soft bits in some situations. In a channel coded system, a soft bit is calculated for soft decision decoding. In general, a log-likelihood ratio of the coded bit is calculated and used as a soft bit. Among the surviving candidates, Sᵢ⁰ is the set of modulation symbols whose i-th bit equals to ‘0’, and Sᵢ¹ is the set of modulation symbols whose i-th bit equals to ‘1’. Let dᵢ⁰ and dᵢ¹ be the set of ASEDs corresponding to Sᵢ⁰ and Sᵢ¹, respectively. Then, the log-likelihood ratio of i-th bit of the modulation symbol s is calculated as follows:
Λᵢ=min(dᵢ¹)−min(dᵢ⁰). Equation (7)
Equation (7) works for the MLD receiver. However, in QRD-M algorithm, there is a possibility that either Sᵢ⁰ or Sᵢ¹ may be an empty set, which leads to the failure of Equation (7).

In most wireless communication systems where channel coding is employed, soft bit information is needed to allow soft decision decoding. However, no method for soft bit generation in a QRD-M MIMO detector has been disclosed. Straightly following the standard QRD-M detection procedure would result in difficulty in obtaining soft bit information. Specifically, there is a possibility that Equation (7) fails since either set Sᵢ⁰ or Sᵢ¹ could be empty.

Therefore, it is desirable to provide a more robust method for generating soft bit information in a QRD-M receiver.

### SUMMARY

The present invention is related to a method and apparatus for QR decomposition-based MIMO detection and soft bit generation. QR decomposition is performed on the MIMO channel matrix H to compute a Q matrix and an R matrix such that H=QR. The Q matrix is a unitary matrix and the R matrix is an upper triangular matrix. The R matrix, or diagonal elements of the R matrix, is stored in a memory. An \tilde{R} matrix is computed by dividing elements in each row of the R matrix with a corresponding diagonal element of the R matrix. A \tilde{Y} vector is computed by dividing each element of the received symbol vector Y with a corresponding diagonal element of the R matrix. A tree search process is performed using the \tilde{R} matrix and the \tilde{Y} vector to generate an approximate maximum likelihood (ML) estimate of transmitted symbols. When a rectangular constellation is used, in-phase (I) components and quadrature (Q) components of the received symbols may be separately processed for the tree search process. Constellation points may be restricted at each stage of the tree search process to reduce the complexity. Alternatively, a decoding may be performed first to generate an estimate of the transmitted symbols and the constellation points may be restricted based on the decoding results to reduce the constellation points.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a high level block diagram of a transmitter and a receiver in accordance with the present invention;

FIG. 2 is a detailed block diagram of a QRD-M receiver of FIG. 1 in accordance with the present invention; and

FIG. 3 shows constellation point selection for reducing complexity of the QRD-M receiver in accordance with the present invention.

### DETAILED DESCRIPTION OF THE PREFERRED EMBODIMENTS

The present invention is applicable to both multi-carrier system, (such as orthogonal frequency division multiplexing (OFDM)), and a single carrier system.

The present invention provides a method to reduce complexity of the conventional QRD-M receiver while achieving the same or similar performance. The present invention also provides a method to generate soft bits for soft decision decoding in the QRD-M receiver. Compared to the conventional method, the present invention significantly reduces receiver complexity while achieving the same or similar performance.

The receiver may be included in a wireless transmit/receive unit (WTRU) or a Node-B. The terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. The terminology “Node-B” includes but is not limited to a base station, a site controller, an access point (AP), or any other type of interfacing device capable of operating in a wireless environment.

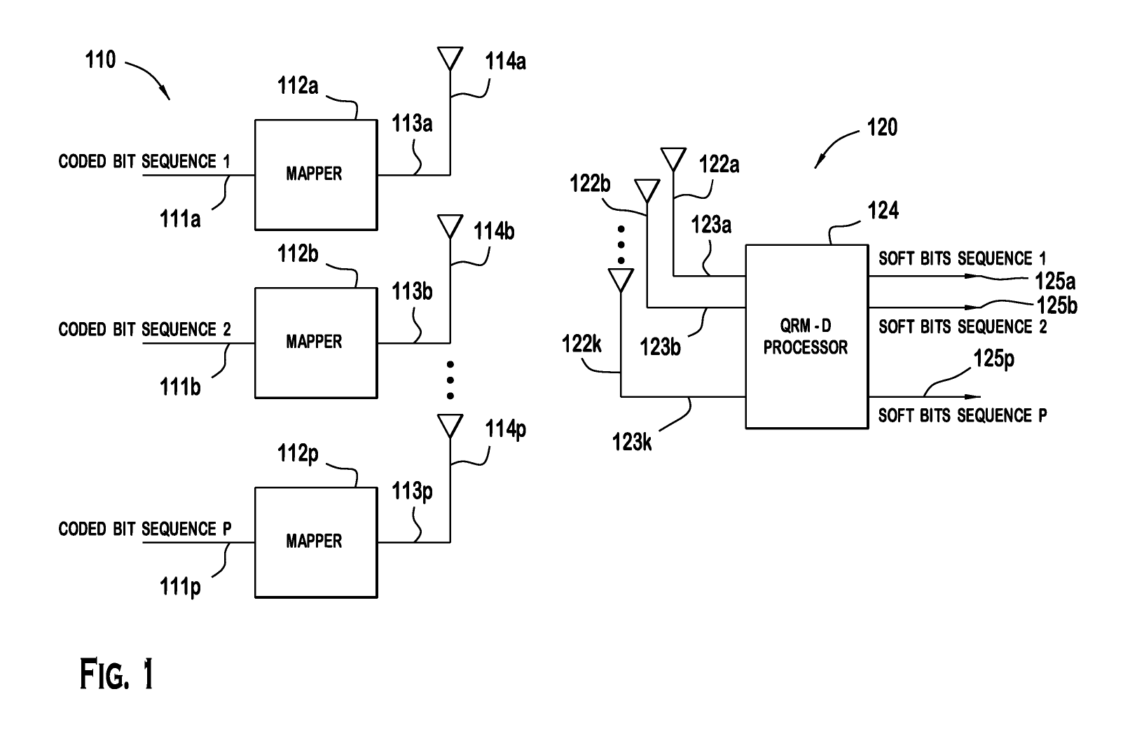

FIG. 1 is a high level block diagram of a transmitter 110 and a receiver 120 in accordance with the present invention. The transmitter 110 includes a plurality of mappers 112a-112p and a plurality of antennas 114a-114p. The receiver 120 includes a plurality of antennas 122a-122k and a QRM-D processor 124. It should be noted that the transmitter 110 and the receiver 120 include many other processing components and those components are not shown in FIG. 1 for simplicity.

At the transmitter 110, information bits are encoded by at least one encoder (not shown), and the encoded bits are divided into P coded bit sequences 111a-111p. Bits on each of the P coded bit sequences 111a-111p are mapped separately to symbols by corresponding mappers 112a-112p according to a modulation scheme. All P symbols 113a-113p are then transmitted via P transmit antennas 114a-114p. At the receiver 120, signals are received by the K receive antennas 122a-122k. The QRM-D processor 124 processes all the received signals 123a-123k and outputs P soft bit streams 125a-125p for decoding.

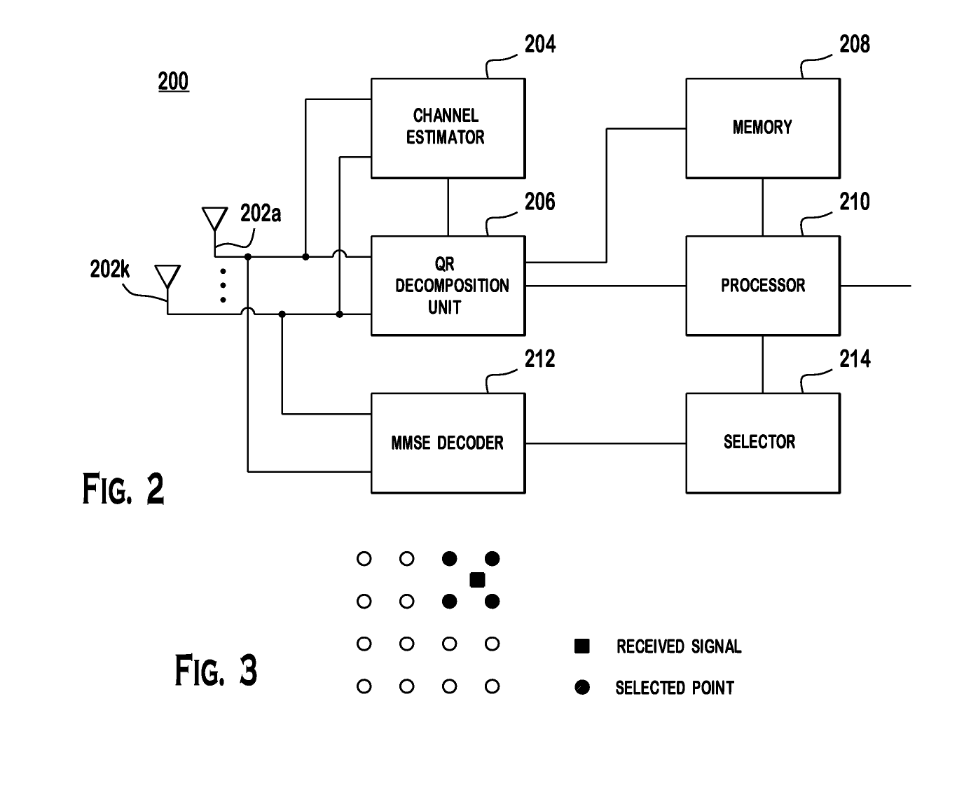

FIG. 2 is a detailed block diagram of a QRD-M receiver 200 in accordance with the present invention. The receiver 200 includes a plurality of antennas 202a-202k, a channel estimator 204, a QR decomposition unit 206, a memory 208, a processor 210, an MMSE decoder 212 (optional), and a selector 214 (optional). The receiver 200 receives symbols simultaneously with multiple antennas 202 that are transmitted via multiple streams from a transmitter. The simultaneously received symbols are represented by a vector Y. The channel estimator 204 generates a MIMO channel matrix H. The MIMO channel matrix H is sent to the QR decomposition unit 206. The QR decomposition unit 206 performs QR decomposition of the MIMO channel matrix H to compute a Q matrix and an R matrix such that H=QR, as stated before. The Q matrix is a unitary matrix and the R matrix is an upper triangular matrix. The Q matrix and R matrix are sent to the processor 210 and the R matrix is stored in the memory 208.

The processor 210 computes an \tilde{R} matrix by dividing elements in each row of the R matrix with a corresponding diagonal element of the R matrix rₙₙ as follows:

$$\tilde{R} = ( \begin{matrix}1 & {r}_{12}^{′} & … & {r}_{1 M}^{′} \\ 0 & 1 & … & ⋮ \\ 0 & 0 & ⋰ & 1 \\ 0 & 0 & 0 & 0\end{matrix} ) . \qquad Equation ( 8 )$$

The processor 210 then computes a \tilde{Y} vector by dividing each element of the vector Y with a corresponding diagonal element of the R matrix as follows:
\tilde{y}ₙ=yₙ/rₙₙ. Equation (9)

The processor 210 then performs a tree search process using the \tilde{R} matrix and the \tilde{Y} vector as in the conventional tree search process to generate an ML estimate of transmitted symbols.

Since the non-zero diagonal elements of the \tilde{R} matrix are all one (1) due to the normalization performed to generate the \tilde{R} matrix, it is possible to separate the I components and Q components of the received symbols, (i.e., Y vector), during metric calculation, (i.e., SED calculation), when a rectangular signal constellation, (e.g., quadrature amplitude modulation (QAM)), is used. When calculating metrics for the m-th stage, signals from all previous stages, (determined by a set of candidate nodes), are subtracted from the received signal, similar to the conventional QRD-M process as shown in Equation (4). SEDs between the resulting signal in Equation (4) and each of the constellation points are calculated. As I/Q components may be separated and the de-rotation is performed during generation of the \tilde{R} matrix, the computational complexity is dramatically reduced.

In this case, each SED is calculated as follows:
λ_{mg}²=(Re(zₘₜ)−Re(c_{g}))²+(Im(zₘₜ)−Im(c_{g}))²; Equation (10)
which requires only two real multiplications. More importantly, each term in Equation (10) may be reused \sqrt{G} times for a square constellation modulation, therefore further reduces total complexity by a factor of \sqrt{G}.

The complexity of the QRD-M detection process in accordance with the present invention becomes 2P\sqrt{G}M. Using the same example of P=4, G=64 and M=16, the complexity of the QRD-M receiver in accordance with the present invention is only 1/24 of the conventional QRD-M receiver.

The processor 210 then generates soft bits according to the accumulated SED and the surviving path list. The processor 210 multiplies the soft bit of the n-th stage by squared magnitude of the n-th diagonal element of the R matrix stored in the memory 208. This is to undo the noise amplification when computing the \tilde{Y} vector.

The present invention also provides a simple method to calculate approximate soft bit value. Without loss of generality, it is assumed that Sᵢ⁰ is empty, which means that the i-th bit of each surviving node equals to ‘1’. The corresponding SED dᵢ⁰ does not exist in the conventional QRD-M detection method. The present invention provides an approximation method to calculate dᵢ⁰, when the surviving set Sᵢ⁰ is empty.

Let {d} be the set including SED corresponding to all survived node. It is then straightforward to see that:
dᵢ⁰≧max(d). Equation (11)

In accordance with the present invention, dᵢ⁰ is approximated as follows:
dᵢ⁰≈μ·max(d); Equation (12)
where μ is a positive number greater than or equal to one (1). In a preferred embodiment of the invention, it is set to one (1).

After dᵢ⁰ is calculated, the log-likelihood ratio of the i-th bit is calculated successfully according to Equation (7).

The QRD-M receiver 200 in accordance with the present invention requires complexity proportional to squared root of modulation alphabet size G. When the constellation size is big, (such as 256QAM), the complexity is still high. In accordance with another embodiment of the present invention, the QRD-M detection process is further simplified. In the conventional QRD-M detection process, at each MIMO layer, the SED between the received signal and all constellation points are calculated. This may not be necessary in some circumstances. In accordance with the present invention, a subset of constellation points is selected first, and only the SED between the selected constellation points and the received signal is calculated. With this scheme, the complexity is further reduced.

FIG. 3 shows constellation point selection for reducing complexity of the QRD-M receiver in accordance with the present invention. FIG. 3 shows 16 QAM as an example. At each stage of the QRD-M detection, the constellation points are restricted to a certain portion of the constellation points based on the value obtained per Equation (4). For example, in FIG. 3, the constellation points are restricted to the four upper right corner points. The SED is then calculated with respect to the upper right four (4) constellation points, instead of all 16 constellation points.

With the de-rotation and normalization during the generation of the \tilde{R} matrix in Equation (8), it is easy to select a subset of constellation points, (in the example of FIG. 3, four (4) points in upper right corner that has smallest distance to the received signal), and the SED is computed only with respect to the selected constellation points. After down selection, the complexity is reduced to 4MP. When modulation order is high, the benefit becomes more significant. The size of the selected subset may vary, depending on parameters such as signal to noise ratio (SNR). As a general rule, smaller subset can be used at high SNR, and larger subset size may be used at low SNR.

In order to further reduce the complexity, (i.e., in order to reduce the number of nodes to be included in the QRD-M calculation), a conventional MMSE decoder 212 may be used before the QRD-M detection process. Any linear decoder may be used as an alternative. The purpose of MMSE detector 212 is to reduce the size of constellation points to be considered in QRD-M algorithm. The MMSE decoder 212 outputs a rough estimation of the transmitted symbols and the selector 214 selects the constellation points based on the output from the MMSE decoder 212. Based on the MMSE decoder output per layer, a subset of constellation is selected by choosing the constellation points that have the predetermined number of minimum distance to the MMSE output. The processor 210 then performs the tree search process based on the restricted constellation points selected by the selector 214.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for QR decomposition-based multiple-input multiple-output (MIMO) detection, the method comprising:
receiving symbols simultaneously via multiple streams, the simultaneously received symbols being represented by a vector Y;
generating a MIMO channel matrix H;
performing QR decomposition on the MIMO channel matrix H to compute a Q matrix and a R matrix such that H=QR, the Q matrix being a unitary matrix and the R matrix being an upper triangular matrix;
storing one of the R matrix and diagonal elements of the R matrix;
computing an \tilde{R} matrix by dividing elements in each row of the R matrix with a corresponding diagonal element of the R matrix;
computing a \tilde{Y} vector by dividing each element of the vector Y with a corresponding diagonal element of the R matrix; and
performing a tree search process using the \tilde{R} matrix and the \tilde{Y} vector to generate a maximum likelihood (ML) estimate of transmitted symbols.

2. The method of claim 1 wherein a rectangular constellation is used for the symbols.

3. The method of claim 2 wherein in-phase (I) components and quadrature (Q) components of the received symbols are separately processed for the tree search process.

4. The method of claim 1 further comprising:
computing soft bits of the transmitted symbols; and
multiplying the soft bits with squared magnitude of the corresponding diagonal element of the R matrix.

5. The method of claim 4 wherein a log likelihood ratio (LLR) (Λᵢ) of the i-th soft bit is calculated as Λᵢ=min(dᵢ¹)−min(dᵢ⁰), dᵢ⁰ and dᵢ⁰ being a set of squared Euclidean distances (SEDs) corresponding to Sᵢ⁰ and Sᵢ⁰, respectively, Sᵢ¹ and Sᵢ⁰) being a set of symbols whose i-th bit equals to ‘1’ and ‘0’, respectively among surviving nodes during the tree search process.

6. The method of claim 5 wherein when Sᵢ⁰ is empty, dᵢ⁰ is calculated as dᵢ⁰=μ·max(d), μ being a positive number greater than or equal to 1 and d being a set of SEDs corresponding all surviving nodes.

7. The method of claim 1 further comprising:
selecting a subset of constellation points at each stage of the tree search process, wherein the tree search process is performed based on the subset of constellation points.

8. The method of claim 1 further comprising:
performing a decoding to generate an estimate of the transmitted symbols; and
restricting constellation points for each stage of the tree search process based on the estimate of the transmitted symbols, wherein the tree search process is performed based on the restricted constellation points.

9. The method of claim 8 wherein the decoding is minimum mean square error (MMSE) decoding.

10. A receiver for QR decomposition-based multiple-input multiple-output (MIMO) detection, the receiver comprising:
a channel estimator for generating a MIMO channel matrix H, the receiver receiving symbols simultaneously via multiple streams from a transmitter, the simultaneously received symbols being represented by a vector Y;
a QR decomposition unit for performing QR decomposition on the MIMO channel matrix H to compute a Q matrix and a R matrix such that H=QR, the Q matrix being a unitary matrix and the R matrix being an upper triangular matrix;
a memory for storing one of the R matrix and diagonal elements of the R matrix; and
a processor for computing an \tilde{R} matrix by dividing elements in each row of the R matrix with a corresponding diagonal element of the R matrix, computing a \tilde{Y} vector by dividing each element of the vector Y with a corresponding diagonal element of the R matrix, and performing a tree search process using the \tilde{R} matrix and the \tilde{Y} vector to generate a maximum likelihood (ML) estimate of transmitted symbols.

11. The receiver of claim 10 wherein a rectangular constellation is used for the symbols.

12. The receiver of claim 11 wherein the processor separately processes in-phase (I) components and quadrature (Q) components of the received symbols for the tree search process.

13. The receiver of claim 10 wherein the processor computes soft bits of the transmitted symbols and multiplying the soft bits with squared magnitude of the corresponding diagonal element of the R matrix.

14. The receiver of claim 13 wherein a log likelihood ratio (LLR) (Λᵢ) of the i-th soft bit is calculated as Λᵢ=min(dᵢ⁰)−min(dᵢ⁰), dᵢ¹ and dᵢ⁰ being a set of squared Euclidean distances (SEDs) corresponding to Sᵢ¹ and Sᵢ⁰, respectively, Sᵢ¹ and Sᵢ⁰ being a set of symbols whose i-th bit equals to ‘1’ and ‘0’, respectively among surviving nodes during the tree search process.

15. The receiver of claim 14 wherein when Sᵢ⁰ is empty, dᵢ⁰ is calculated as dᵢ⁰=μ·max(d), μ being a positive number greater than or equal to 1 and d being a set of SEDs corresponding all surviving nodes.

16. The receiver of claim 10 wherein the processor selects a subset of constellation points for each stage of the tree search process, wherein the tree search process is performed based on the subset of constellation points.

17. The receiver of claim 10 further comprising:
a decoder for performing decoding to generate an estimate of the transmitted symbols; and
a selector for restricting constellation points for each stage of the tree search process based on the estimate of the transmitted symbols, wherein the tree search process is performed based on the restricted constellation points.

18. The receiver of claim 17 wherein the decoder is a minimum mean square error (MMSE) decoder.
